(19) United States
(12) Patent Application Publication
(10) Pub. No.: US 2018/0288832 A1
(43) Pub. Date: Oct. 4, 2018

(54) Heating Electronic Dimmable Windows

(71) Applicant: The Boeing Company, Chicago, IL (US)

(72) Inventors: Morteza Safai, Newcastle, WA (US); Kimberly D. Meredith, Seattle, WA (US)

(21) Appl. No.: 15/477,289

(22) Filed: Apr. 3, 2017

(51) Int. Cl. H05B 3/84; H05B 3/14; H05B 1/02; B64C 1/14; E06B 3/67; E06B 7/28

(52) U.S. Cl. CPC H05B 3/84; H05B 3/145; H05B 1/0236; B64C 1/1484; B64C 1/1492; H05B 2214/02; E06B 7/28; H05B 2203/003; H05B 2203/013; H05B 2203/017; E06B 3/6715

(57) ABSTRACT

An electronic dimmable window is heated by a graphene heating element formed on a transparent panel aligned with and proximal to the electronic dimmable window. The heating element is controlled by a thermostatic control circuit printed on the transparent panel.

### BACKGROUND INFORMATION

### 1. Field

The present disclosure generally relates to electronic dimmable windows, and deals more particularly with heating such windows.

### 2. Background

Electronic dimmable windows (hereinafter “EDWs”) have been proposed for a variety of applications using various technologies. For example, mechanical window shades in some commercial aircraft have been replaced by electrochromatic windows that allow passengers to electronically control the amount of visible light entering the cabin through windows. These windows use an electrochromatic gel sandwiched between two thin panels provided with conductive coatings. Applying a small voltage across the gel causes it to darken, increasing the opacity of the window.

EDW's used in aircraft are subjected to shock, vibration, temperature extremes, repetitive cycling and loading conditions, and high pressures, all of which may impose stresses on EDW components that can reduce their performance and/or reliability. In addition, the low temperatures encountered at high cruise altitudes can cause frost to form on the EDWs, reducing visibility through the window. Heating systems have been proposed for EDWs used in aircraft to address these issues, but none have been completely effective and/or have certain disadvantages.

### SUMMARY

The disclosure relates in general to EDWs, such as those used in aerospace or other vehicles operating in extreme environments, and more specifically to heaters for EDWs.

According to one aspect, an electronic dimmable window assembly is provided comprising an electronic dimmable window panel, and a heater. The heater includes a substantially transparent resistive heating element formed of graphene. The heating element is operable to heat the electronic dimmable window panel.

According to another aspect, an electronic dimmable window assembly is provided for aerospace vehicles. The electronic dimmable window assembly comprises at least one outer windowpane allowing viewing therethrough from inside the aerospace vehicle, an electronic dimmable window panel, and a heater operable to heat the electronic dimmable window panel. The electronic dimmable window panel is spaced inboard of the outer windowpane for controlling light entering the vehicle through the outer window pane. The heater includes a transparent heater panel arranged and aligned side-by-side in a stacked configuration with the outer windowpane and the electronic dimmable window panel. The transparent heater panel includes a transparent substrate and a transparent resistive heating element formed on the transparent substrate.

According to still another aspect, a method is provided of making an electronic dimmable window. The method includes providing an electronic dimmable window panel and forming a graphene heating element on a transparent substrate operable to generate heat. The method also includes mounting the transparent substrate in aligned, side-by-side, i.e. “stacked” relationship with the electronic dimmable window panel such that the heat generated by the graphene heating element is transferred to the electronic dimmable window panel.

One of the advantages of the disclosed examples is that substantially the entire area of an EDW can be heated and defrosted. Another advantage of the disclosed heater is that it is simple, lightweight, durable and shock/vibration resistant. Still another advantage is that the disclosed heater can be embedded into the EDW or placed in locations near the EDW. A further advantage of the disclosed heater is that it employs a transparent heating element over the window opening that does not materially reduce visibility through the window.

The features, functions, and advantages can be achieved independently in various examples of the present disclosure or may be combined in yet other examples in which further details can be seen with reference to the following description and drawings.

### BRIEF DESCRIPTION OF THE DRAWINGS

The novel features believed characteristic of the illustrative examples are set forth in the appended claims. The illustrative examples, however, as well as a preferred mode of use, further objectives and advantages thereof, will best be understood by reference to the following detailed description of an illustrative example of the present disclosure when read in conjunction with the accompanying drawings, wherein:

FIG. 1 is an illustration of a perspective view of an airplane employing EDWs that are heated by the disclosed heating system.

FIG. 2 is an illustration of an exploded, perspective view of one of the EDWs used in the airplane of FIG. 1.

FIG. 3 is an illustration of another exploded, perspective view of the EDW, an inner reveal not shown for clarity.

FIG. 4 is an illustration of the heater viewed in the direction designated as “FIG. 4” in FIG. 3.

FIG. 4A is an illustration similar to FIG. 4 but showing an alternate location and geometry of the heating element.

FIG. 4B is an illustration of another window geometry in which the heating element is arranged as a strip across the middle of the window.

FIG. 5 is an illustration of an isometric view of one example of the heater.

FIG. 6 is an illustration of a sectional view taken along the line 6-6 FIG. 5.

FIG. 7 is an illustration of a schematic circuit diagram of a control circuit forming part of the heater shown in FIG. 4.

FIG. 8 is an illustration of a perspective view of a section of a graphene resistive heater element forming part of the heater shown in FIGS. 4, 5 and 6.

FIG. 9 is an illustration of the skeletal formula for graphene.

FIG. 10 is an illustration of a cross-sectional view of one of the EDWs shown in FIG. 1.

FIG. 11 is an illustration of a cross sectional view designated as “FIG. 11” in FIG. 10.

FIG. 12 is an illustration of a cross-sectional view of the area designated as “FIG. 12” in FIG. 11.

FIG. 13 is an illustration of a cross sectional view similar to FIG. 12 but showing an alternate example of the EDW panel.

FIG. 14 is an illustration of a cross-sectional similar to FIG. 11, but showing another example of the heater.

FIG. 15 is an illustration of a cross-sectional view similar to FIG. 11 but showing a further example of the heater.

FIG. 16 is an illustration of a cross-sectional view similar to FIG. 11 but showing still another example of the heater.

FIG. 17 is an illustration of a flow diagram of a method of making an electronic dimmable window having a heater.

FIG. 18 is an illustration of a flow diagram of aircraft production and service methodology.

FIG. 19 is an illustration of a block diagram of an aerospace vehicle.

### DETAILED DESCRIPTION

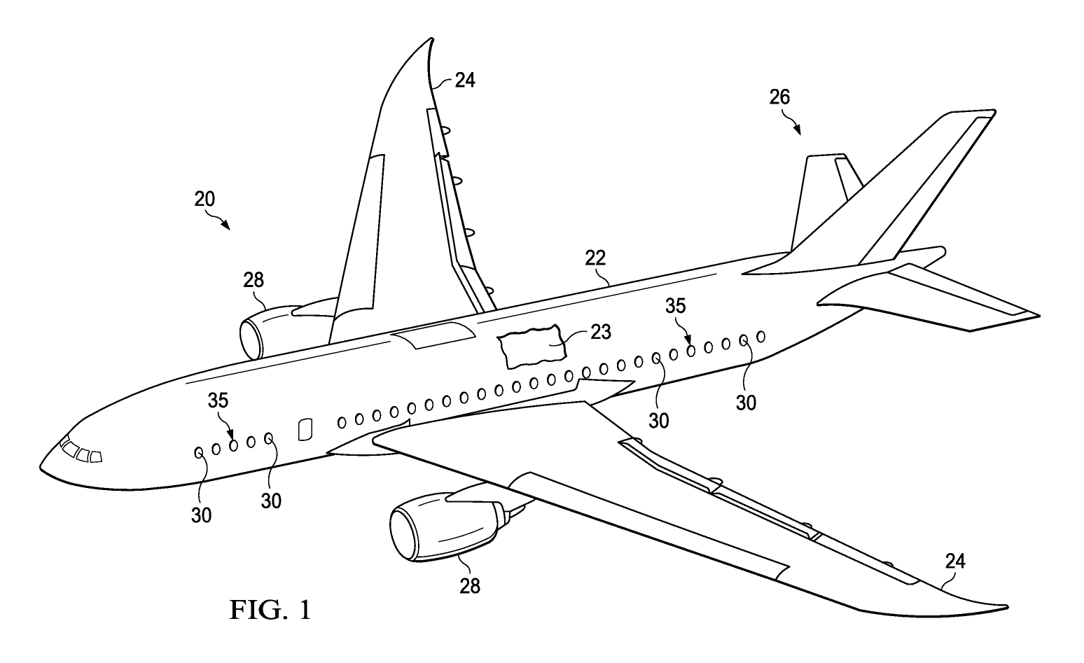

Referring first to FIG. 1, an exemplary vehicle in the form of an airplane 20 includes a fuselage 22 with an interior pressurized cabin 23, wings 24, a tail assembly 26 and a pair of engines 28. The fuselage 22 includes EDW assemblies 30 (sometimes also referred to herein as EDWs) that allow passengers inside the pressurized cabin 23 to view the external environment and which are capable of controlling the amount of visible light entering the pressurized cabin 23. Although an airplane 20 is illustrated, it is to be understood that the disclosed examples can be used in a wide variety of applications employing EDWs, such as buildings and other stationary structures, as well as various forms of mobile platforms including but not limited to other aerospace applications such as rotary aircraft and space vehicles.

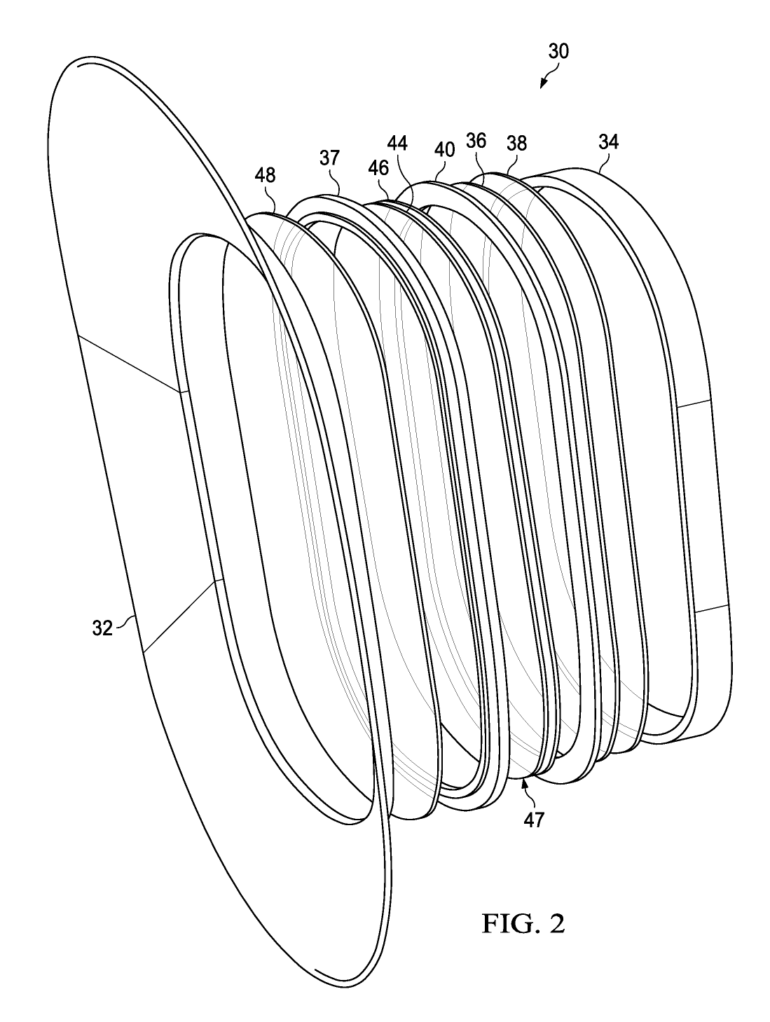

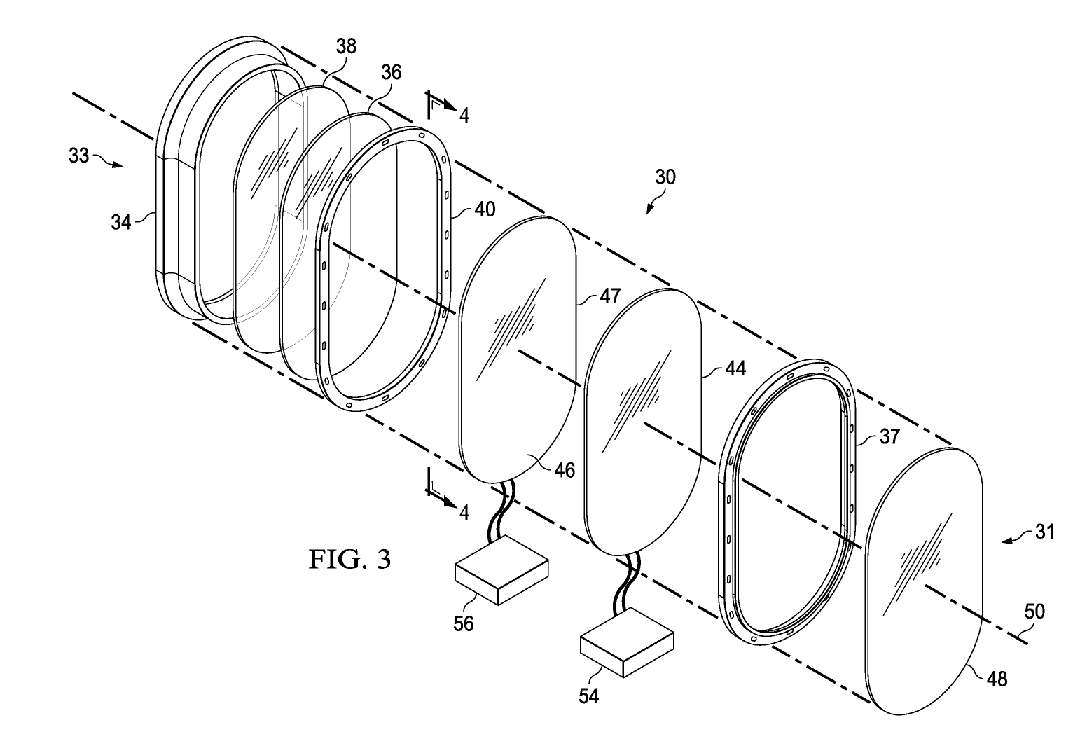

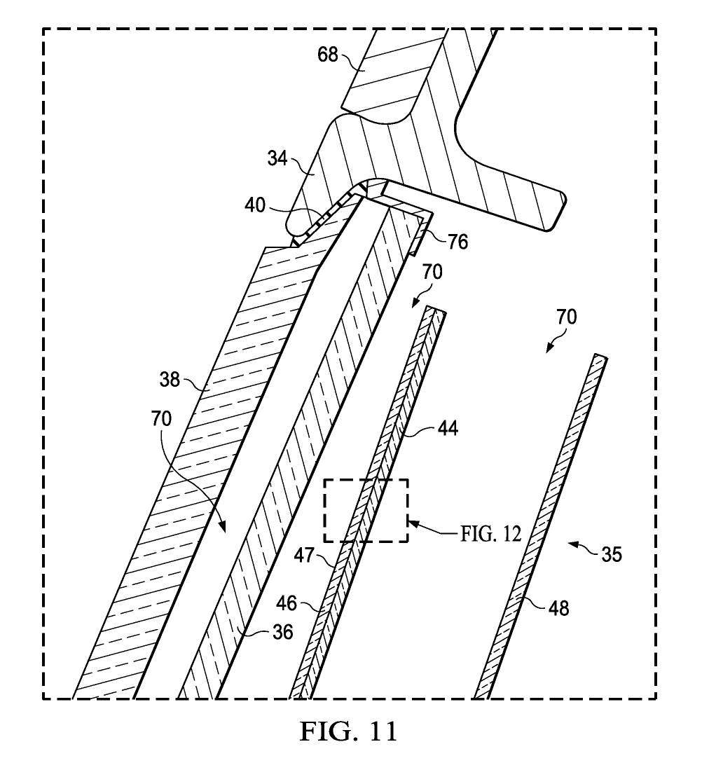

Referring to FIGS. 2, 3 and 4, each of the EDWs 30 is mounted within a window opening 35 in the fuselage 22 and has an inboard side 31 facing the pressurized cabin 23 and an opposite, outboard side 33. The EDW 30 comprises a stacked assembly of window components that are arranged side-by-side (i.e. stacked), and aligned along a central axis 50. Each of the EDWs 30 broadly comprises an outer frame 34 containing inner and outer transparent panes 36, 38 respectively, an EDW (electronic dimmable window panel) 44, a heater 46, and a dust cover 48. The EDW panel 44 is constructed in accordance with any of a variety of so-called “smart window” technologies, such as, without limitation, electrochromatic, photochromic, thermochromic, suspended particle, micro-blind and polymer dispersed liquid crystal technologies. The EDW 30 also includes a seal 40 between the outer frame 34 and the EDW panel 44, as well as an inner frame 37, and an inner reveal 32 mounted within the fuselage 22. In the disclosed example, the inner and outer panes 36, 38 are spaced apart to define an air gap 70 therebetween (see FIG. 11), however in other examples the inner and outer panes 36, 38 may be in face-to-face contact with each other. Similarly, depending on the window configuration required for a particular application, air gaps, (not shown in FIGS. 2 and 3) may be present between inner windowpane 36, heater 46, EDW panel 44 and the dust cover 48.

In the case of a commercial aircraft, a large temperature gradient exists between the inside and outside of the pressurized cabin 23. For example, at cruise altitudes, cabin temperatures can be between 65° F. and 75° F. while the outside temperatures can be between −75° F. and −80° F. Referring to FIGS. 2 and 3, the heater 46 generates thermal energy that reduces the effect of these temperature extremes as well as the effect of shock, vibration and load/temperature cycling, on the EDW. The heater 46 includes a heater panel 47 positioned at a selected location between the outer pane 38 and the dust cover 48, and an electronic heater controller 56.

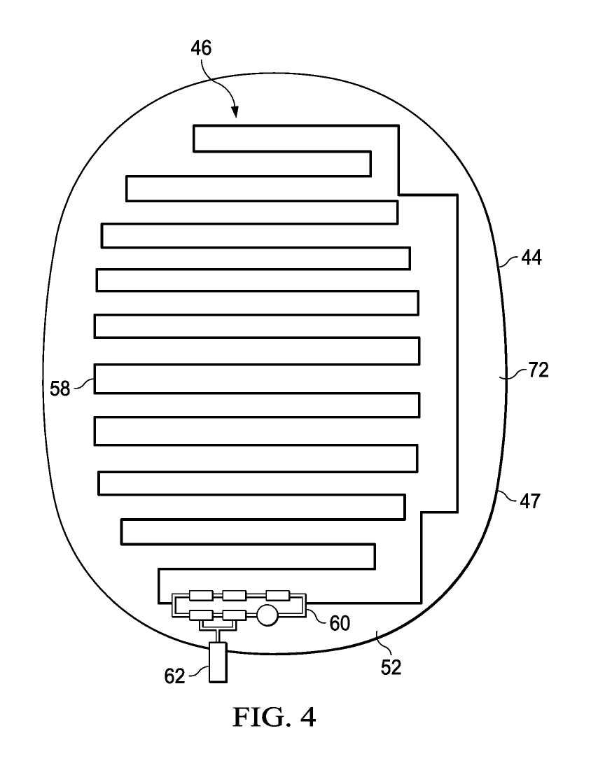

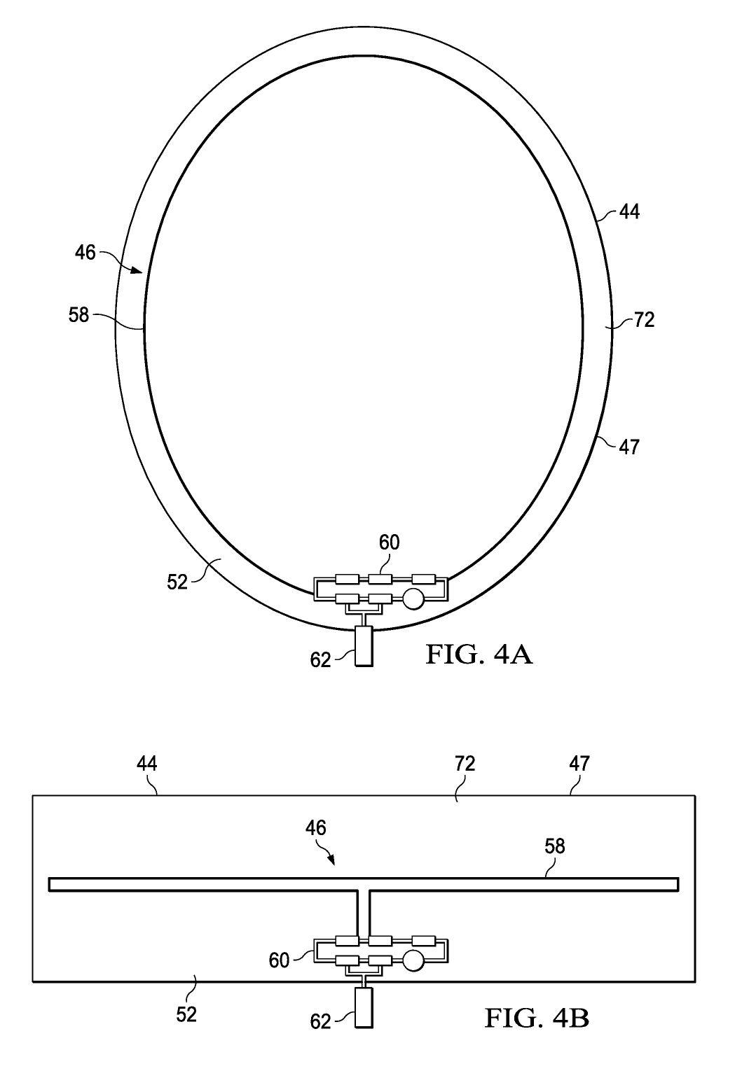

In the example shown in FIGS. 2 and 3, the heater panel 47 is located between the inner pane 36 and the EDW panel 44. In other examples described below however, depending upon the application, the heater panel 47 may be located in other locations within the EDW 30. The heater controller 56 may be separate from, and located near the heater panel 47 as shown in FIG. 3, or may comprise a control circuit 60 that is formed directly on the heater panel 47 as shown in FIG. 4. An electronic controller 54 controls the operation of the EDW panel 44, while heater controller 56 controls the operation of the heater 46. In other examples, the functions provided by controllers 54, 56 may be integrated into a single controller (not shown) which is located in proximity to the EDW 30 or in a remote location within the airplane 20. The EDW 30 configuration shown in FIGS. 2 and 3 is merely illustrative of a wide range of window configurations that are commonly used in airplanes, and other vehicles, particularly those employing pressurized cabins.

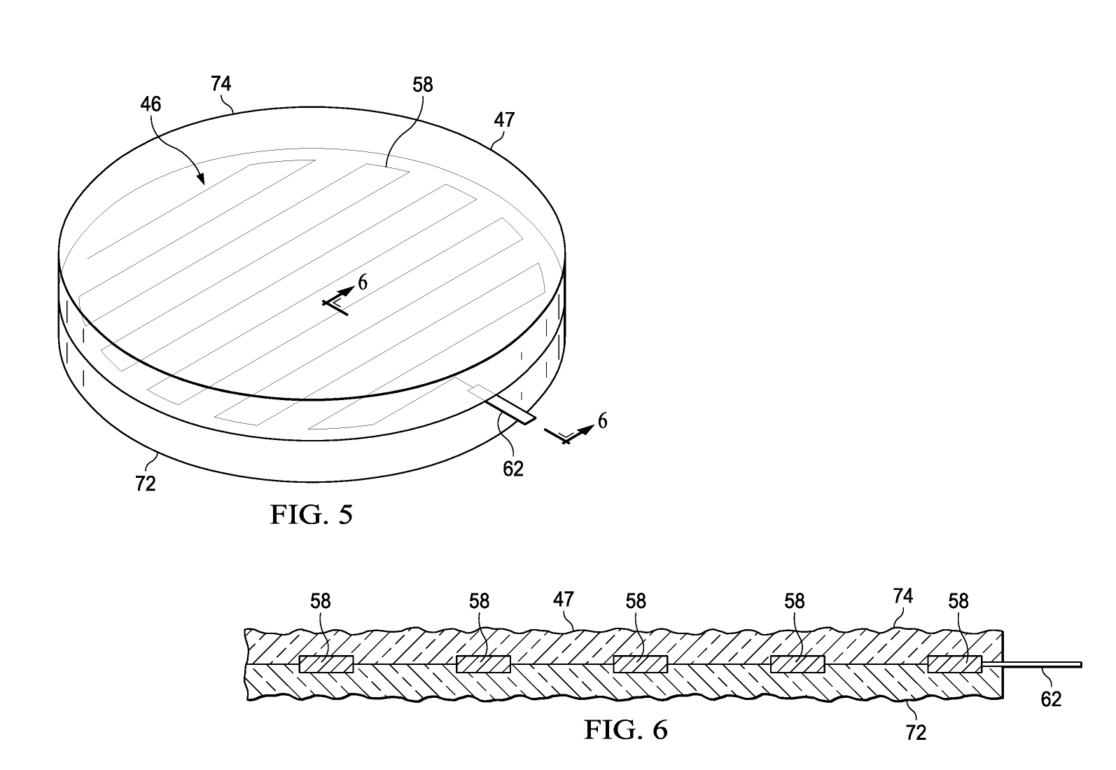

Referring now to FIGS. 4, 5 and 6, the heater panel 47 comprises a graphene resistive heating element 58 (hereinafter referred to as a “heating element”) sandwiched between two transparent panels 72, 74 respectively, each of which may be a suitable transparent film, plastic or glass. One of the panels 72 acts as a substrate on which the heating element 58 is formed while the other panel 74 acts as a protective covering to prevent damage to the heating element 58. In the illustrated example, the heating element is arranged in a serpentine pattern extending substantially over the entire area of the EDW panel 44. In other examples, however, the location and/or areal density of the heating element 58 may be tailored to suit particular window configurations and applications. For example, as shown in FIG. 4A, the heating element 58 may be located only around the outer edge of a window, while in another example shown in FIG. 4B, the heating element 58 may be arranged as strip across the middle of a window. In still other examples, the areal density of the heating element 58 may be greater or less in certain areas of a particular window, for example by varying the number and/or width of the heating element 58 in order to address localized thermal conditions.

The heating element 58 is effectively a strong and flexible, transparent circuit trace formed on a transparent substrate (e.g. panel 72) that is coupled with either the external control circuit 56 described previously in connection with FIG. 3, or a control circuit 60 that is integrated into the heater panel 47. In the example shown in FIG. 4, the integrated control circuit 60 is formed on the surface 52 of the transparent panel 72 near its periphery, along with the heating element 58, using conventional printed circuit techniques. A flex circuit located along an edge of the transparent panels 72, 74 couples the control circuit 60 with a suitable source of electrical power (not shown).

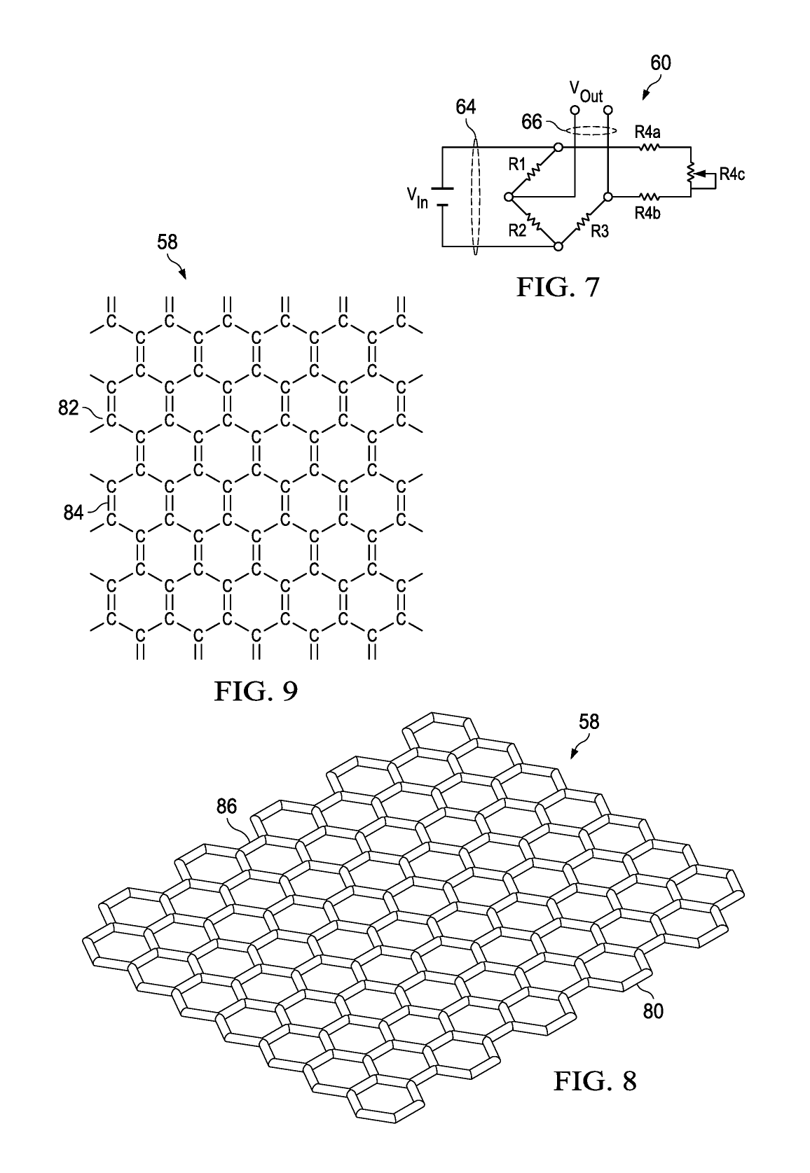

FIG. 7 illustrates one example of the control circuit 60 which effectively acts as a thermostatic controller for adjusting the temperature of the heater 46. An external power source Vin is coupled via input leads 64 on the flex circuit 62 to a bridge circuit comprising resistors R1, R2, R3, R4a, R4b and a variable resistor R4c which allows adjustment of the DC (direct current) output voltage Vₒᵤₜ. The amount of heat generated by the heating element 58 is dependent upon the output voltage Vₒᵤₜ. A set of output leads 66 are coupled with and apply the DC output voltage Vₒᵤₜ to the heating element 58. In typical applications, the output voltage Vₒᵤₜ is relatively low, for example on the order of several volts. In other examples, the control circuit 60 can be configured to sense the temperature of the heating element 58.

In one typical commercial aircraft application, the heating element 58 can produce, for example and without limitation, approximately 10 watts of power that is converted into thermal energy. This thermal energy is transmitted to the EDW panel 44 by conduction, radiation, and/or convection, thereby preventing the temperature of the EDW panel 44 from falling lower than a threshold value, below which undesirable stress may applied to the components of the EDW panel 44, and/or frost may form on the EDW panel 44.

Although not shown in the Figures, the control circuit 60 can include a feedback loop in which the temperature of the heating element 58 is sensed, and the control circuit 60 responds by adjusting the amount of voltage applied to the heating element 58. Thus, for example, when the airplane 20 is on the ground where ambient temperatures are above a threshold value, the control circuit 60 will shut off the heating element 58. Furthermore, it may be possible to employ additional control circuitry allowing the amount and timing of the heat generated by the heating element 58 to the programmed, such that the temperature of the heating element 58 is controlled according to a prescribed schedule or profile, altitude, or specific environmental or service conditions. Additionally, one or more temperature sensors (not shown) located on or near the window may be employed to provide temperature information to the control circuit 60 which it then uses to adjust the temperature of the heating element 58.

Referring now to FIGS. 8 and 9, in the exemplary example, the graphene forming the heating element comprises a single layer 80 of hexagonal rings 86 one micron thick, forming a honeycomb-like lattice. Graphene is a crystalline allotrope of carbon comprising a single two dimensional, atomic scale, hexagon lattice in which one carbon atom 82 forms each vertex. Each graphene molecule is a fully planar shape in which the C—C—C (carbon-carbon-carbon) angle of the bonds 84 is 120°. The heating element may be formed on a transparent substrate such as the transparent panel 72 by any of various known techniques, including physical vapor deposition (PVD), chemical vapor deposition (CVD) or printing. In other examples, the heating element 58 may comprise more than one layer of graphene, resulting in a three-dimensional honeycomb of hexagonal arranged carbon atoms that allows the heating element 58 to carry higher levels of electrical current.

Graphene is highly electrically and thermally conductive, is exceptionally strong, while being both stiff elastic, allowing it to stretch without breaking. Because graphene is extremely thin, it is also substantially transparent, allowing visible light to be transmitted therethrough without distortion or material attenuation. Thus, because the heating element 58 is transparent, it may be arranged to extend over most of the area of the transparent panel 72 without reducing the amount of light passing through the EDW 30, or acting as a visual distraction. Moreover, because the heating element 58 may extend over a wide area of the transparent panel 72, a correspondingly wide area of the EDW panel 44 is uniformly heated.

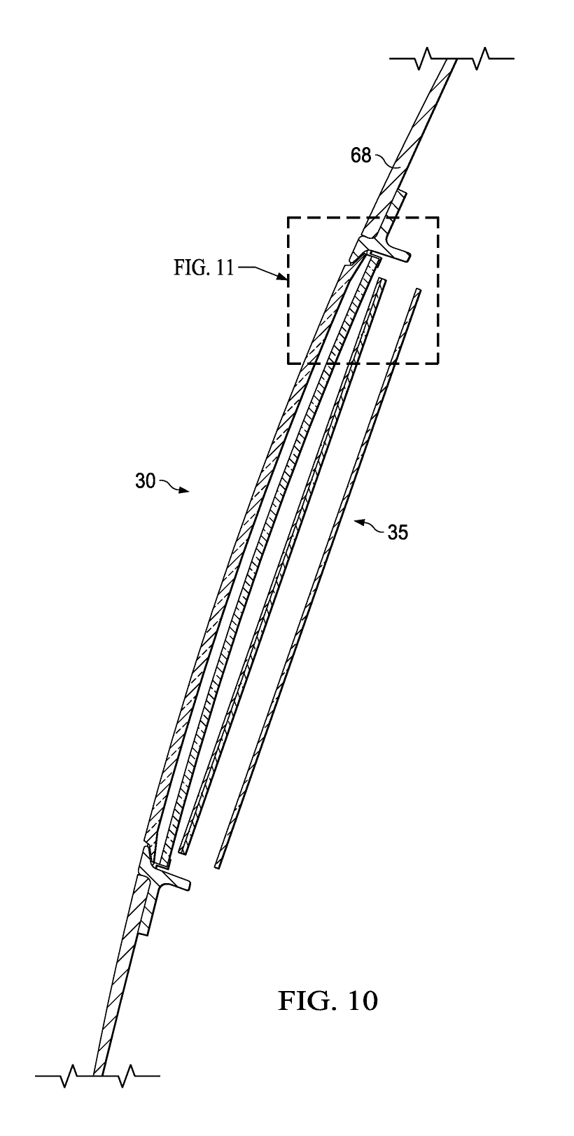

Attention is now directed to FIGS. 10, 11 and 12 which illustrate one example of an EDW 30 suitable for use in aerospace or other vehicles, such as the airplane shown in FIG. 1. The EDW 30 broadly comprises an inner transparent pane 36 and outer transparent pane 38 held by a clip 76 within an outer frame 34. The outer frame 34 is secured to the fuselage skin 68 by any suitable means. A seal 40 is located between the outer pane 38 and the outer frame 34. In the illustrated example, an air gap 70 is present between the inner and outer panes 36, 38 respectively, however in other examples these two panes may be in face-to-face contact with each other. An EDW panel 44 of the type previously described is spaced inboard of the inner pane 36, while the dust cover 48 is spaced inboard of the EDW panel 44. Air gaps 70 are present between the EDW 44 panel and the inner pane 36, and between the dust cover and the EDW panel 44. Although not shown the Figures, either or both the inner and outer panes 36, 38 respectively may have one or more surface coatings, such as a coating (not shown) that limits passage therethrough of infrared radiation.

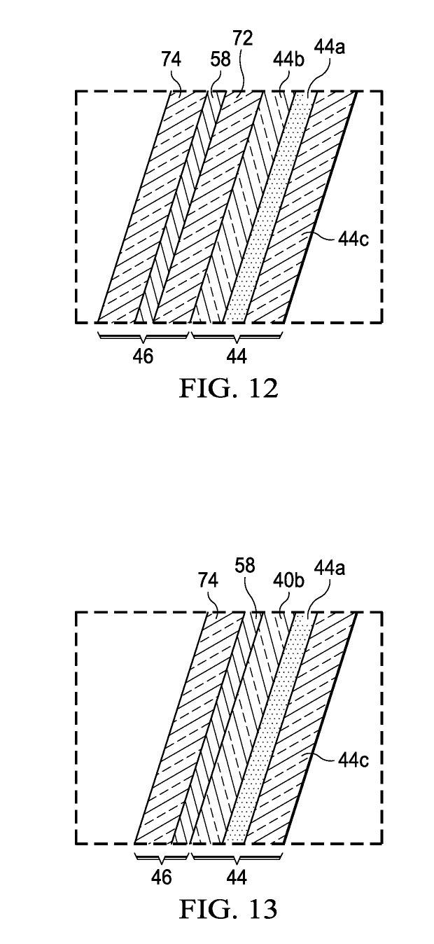

The EDW panel 44 and the dust cover 48 may be supported by any suitable means, such as by the inner reveal 32 (FIG. 2). In this example, the heater panel 47 is mounted in face-to-face contact with the outboard side of the EDW panel 44. Referring to FIG. 12, in this example, the EDW panel 44 comprises a layer of electronic gel 44a sandwiched between two transparent panels 44b, 44c. The heater panel 47 comprises a graphene heating element 58 sandwiched between two transparent panels 72, 74 wherein panel 72 is positioned in face-to-face contact with the transparent panel 44b. In this example, the graphene heating element 58 may be formed on either of the transparent panels 72, 74, and in either case, the outboard transparent panel 74 protectively covers the graphene heating element 58. In other examples, depending upon the EDW panel technology, the heating element 58 may be embedded within, or otherwise integrated into the EDW panel 44.

FIG. 13 illustrates an alternate example of the heater 46 wherein the graphene heating element 58 is formed either on the outboard face of transparent panel 40b or on the inboard face of an overlying transparent panel 74. In effect, in the example shown in FIGS. 13, the heating element 58 is essentially embedded in/integrated with the EDW panel 44.

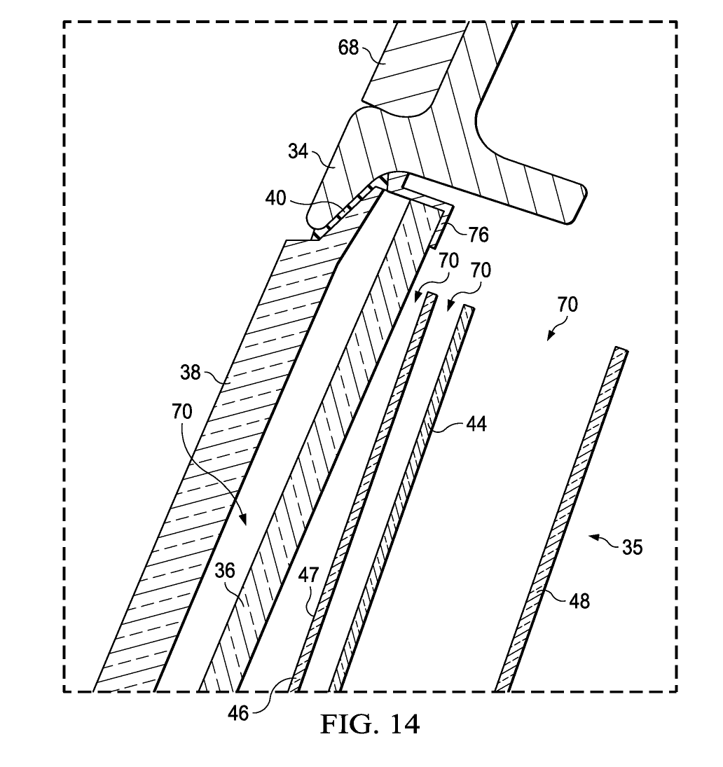

FIG. 14 illustrates another example of the EDW 30 wherein the heater panel 47 is mounted between and is in spaced relationship to the EDW panel 44 and the inner pane 36. In this example, the heater panel 47 acts as a thermal barrier which warms the volume of airspace within the gaps 70 between the inner pane 36 and the EDW panel 44. In this example, the heater panel 47 may be mounted along its periphery using clips (not shown) or other fasteners attached to either the outer frame 34, the inner reveal 32 or other structures that may be present near the window opening 35.

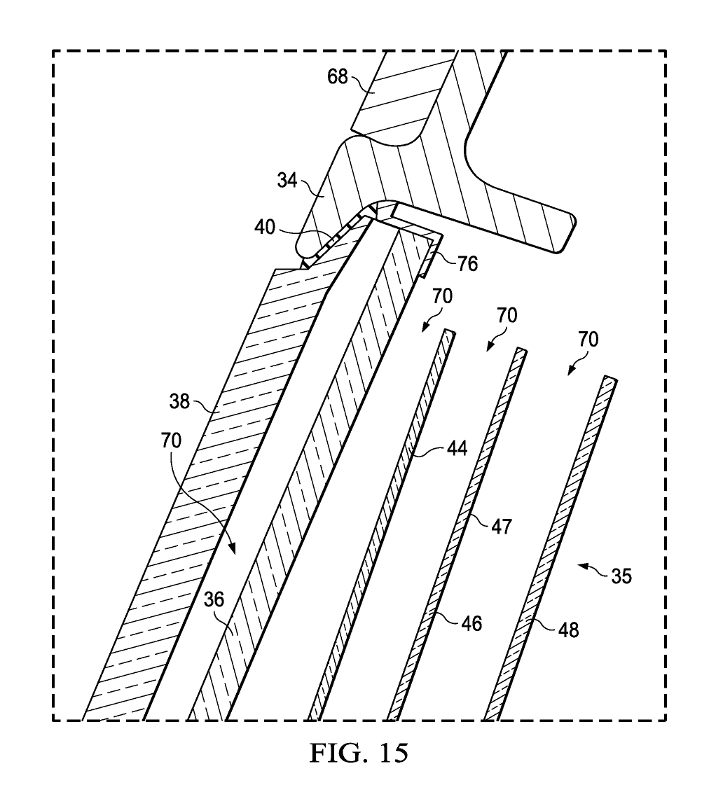

FIG. 15 illustrates a further example of the EDW 30 wherein the heater panel 47 is mounted between and in spaced relationship to the EDW panel 44 and the dust cover 48. Although located further inboard from external source of cold air, and particularly the inner pane 36, the heater 46 may generate enough heat near the inboard side of the EDW panel 44 to prevent frosting of and/or undue stresses within the EDW panel 44.

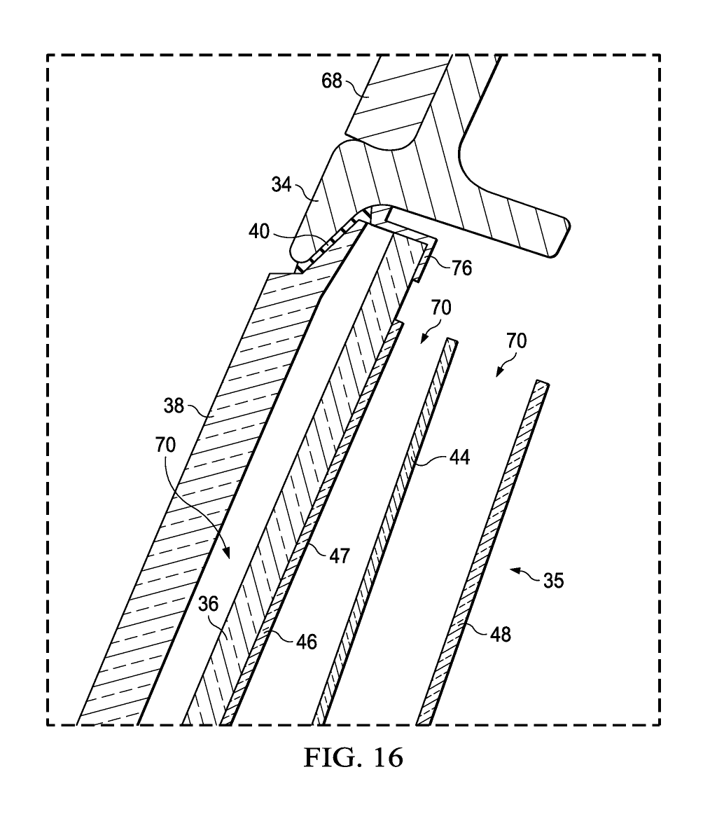

FIG. 16 illustrate still another example of the EDW 30 in which the heater panel 47 is mounted in face-to-face contact with the inboard side of the inner pane 36. The heat generated by the heater 46 effectively serves as a thermal barrier against cold air reaching the EDW panel 44.

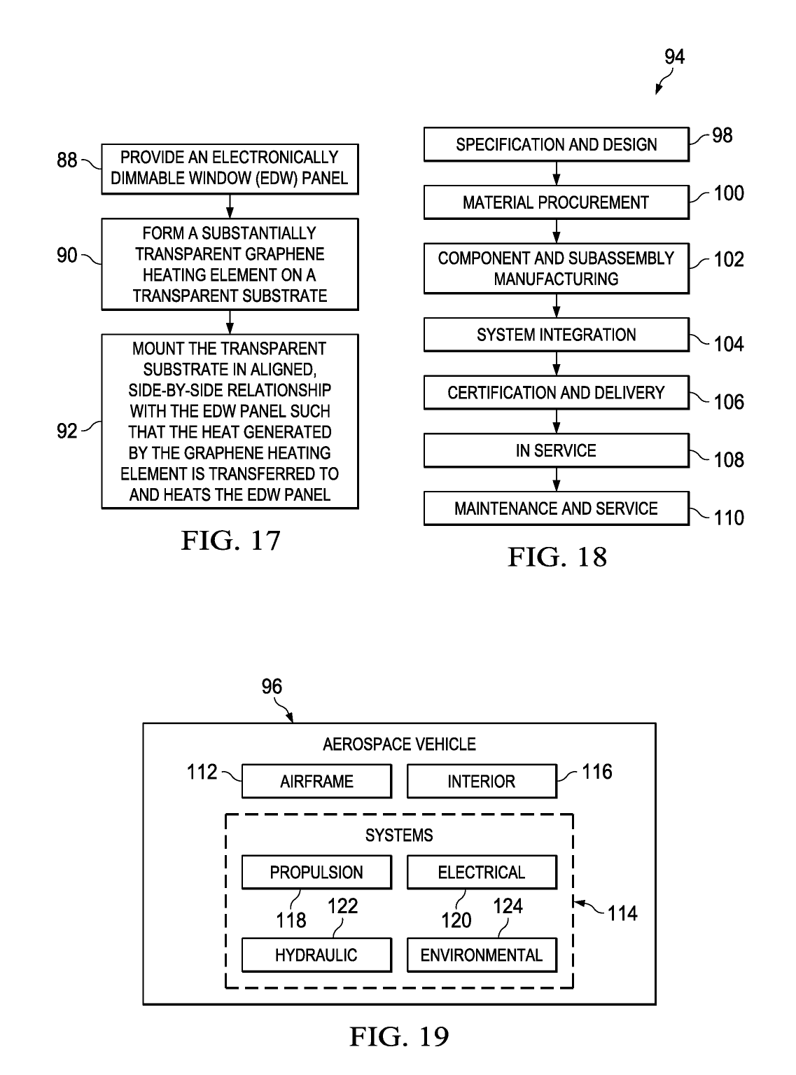

Attention is now directed to FIG. 17 which broadly illustrates the overall steps of a method of making an electronic dimmable window 30. Beginning at 88, an electronic dimmable window panel 44 is provided, which as previously discussed, may be constructed and operate using any of a variety of technologies, including, but not limited to electrochromatic technologies. At 90, a substantially transparent graphene heating element 58 is formed on a transparent substrate 72 which, as previously discussed, may comprise a glass or transparent plastic panel or film. For example, the substantially transparent resistive heating element 58 may comprise a layer of graphene arranged as an electrical circuit and powered by an electrical energy source. At 92, the transparent substrate 72 is mounted in aligned side-by-side, stacked relationship with the EDW panel 44 such that the heat generated by the graphene heating element 58 is transferred to and heats the EDW panel 44.

Examples of the disclosure may find use in a variety of window and window applications, particularly those in which the window are subjected to harsh environmental conditions including shock, vibration, temperature extremes, and load and temperature cycling. For example, examples have application vehicles used in the aerospace, marine, and automotive industries. Thus, referring now to FIGS. 18 and 19, examples of the disclosure may be used in the context of an aerospace manufacturing and service method 94 as shown in FIG. 18 and an aerospace vehicle 96 as shown in FIG. 19. Aerospace applications of the disclosed examples may include, for example, without limitation, cabin windows and similar viewports in airplanes, rotary craft and spacecraft. During pre-production, exemplary method 94 may include specification and design 98 of the aerospace vehicle 96 and material procurement 100. During production, component and subassembly manufacturing 102 and system integration 104 of the aerospace vehicle 96 takes place. Thereafter, the aerospace vehicle 96 may go through certification and delivery 106 in order to be placed in service 108. While in service by a customer, the aerospace vehicle 96 is scheduled for routine maintenance and service 110 which may also include modification, reconfiguration, refurbishment, and so on.

Each of the processes of method 94 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. 19, the aerospace vehicle 96 produced by exemplary method 94 may include an airframe 112 with a plurality of systems 114 and an interior 116. Examples of high-level systems 114 include one or more of a propulsion system 118, an electrical system 120, a hydraulic system 122 and an environmental system 124. Any number of other systems may be included. Although an aerospace example is shown, the principles of the disclosure may be applied to other industries, such as the marine and automotive industries.

Systems and methods embodied herein may be employed during any one or more of the stages of the production and service method 94. For example, components or subassemblies corresponding to production process 102 may be fabricated or manufactured in a manner similar to components or subassemblies produced while the aerospace vehicle 96 is in service. Also, one or more apparatus examples, method examples, or a combination thereof may be utilized during the production stages 102 and 104, for example, by substantially expediting assembly of or reducing the cost of the aerospace vehicle 96. Similarly, one or more of apparatus examples, method examples, or a combination thereof may be utilized while the aerospace vehicle 96 in service, for example and without limitation, to maintenance and service 110.

As used herein, the phrase “at least one of”, when used with a list of items, means different combinations of one or more of the listed items may be used and only one of each item in the list may be needed. For example, “at least one of item A, item B, and item C” may include, without limitation, item A, item A and item B, or item B. This example also may include item A, item B, and item C or item B and item C. The item may be a particular object, thing, or a category. In other words, at least one of means any combination items and number of items may be used from the list but not all of the items in the list are required.

The description of the different illustrative examples has been presented for purposes of illustration and description, and is not intended to be exhaustive or limited to the examples in the form disclosed. Many modifications and variations will be apparent to those of ordinary skill in the art. Further, different illustrative examples may provide different advantages as compared to other illustrative examples. The example or examples selected are chosen and described in order to best explain the principles of the examples, the practical application, and to enable others of ordinary skill in the art to understand the disclosure for various examples with various modifications as are suited to the particular use contemplated.

What is claimed is:

1. An electronic dimmable window assembly, comprising:
an electronic dimmable window panel; and
a heater including a substantially transparent resistive heating element formed of graphene and operable to heat the electronic dimmable window panel.

2. The electronic dimmable window assembly of claim 1, wherein:
the heater includes a transparent substrate, and
the heating element is formed on the transparent substrate.

3. The electronic dimmable window assembly of claim 2, further comprising:
a thermostatic control circuit located on the transparent substrate and operable to control the heating element.

4. The electronic dimmable window assembly of claim 2, wherein:
the heater further includes a transparent panel configured to protectively cover the heating element, and
the heating element is sandwiched between the transparent substrate and the transparent panel.

5. The electronic dimmable window assembly of claim 1, wherein:
the heating element is formed on the electronic dimmable window panel, and
the heater further includes a transparent panel configured to protectively cover the heating element.

6. The electronic dimmable window assembly of claim 1, wherein:
the heater includes first and second transparent panels, and
the heating element is sandwiched between the first and second transparent panels.

7. The electronic dimmable window assembly of claim 1, further comprising:
at least one transparent windowpane, wherein
the electronic dimmable window panel is spaced apart from the transparent windowpane,
the heater includes a transparent panel having the heating element formed thereon, and
the transparent panel has the heating element formed thereon is disposed between the at least one transparent window pane and the electronic dimmable window panel.

8. The electronic dimmable window assembly of claim 1, wherein the heating element is embedded in the electronic dimmable window panel.

9. The electronic dimmable window assembly of claim 1, wherein:
the heater includes a transparent substrate,
the heating element is formed on the transparent substrate, and
the electronic dimmable window panel and the transparent substrate are arranged and aligned side-by-side such that light passes through the transparent substrate and the heating element into the electronic dimmable window panel.

10. An electronic dimmable window assembly for a vehicle, comprising:
at least one outer windowpane allowing viewing therethrough from inside the vehicle;
an electronic dimmable window panel spaced inboard of the outer windowpane and operable to control light entering the vehicle through the outer windowpane; and
a heater operable to heat the electronic dimmable window panel, the heater including a transparent heater panel aligned and arranged side-by-side with the outer windowpane and the electronic dimmable window panel, the transparent heater panel including a transparent substrate and a transparent resistive heating element formed on the transparent substrate.

11. The electronic dimmable window assembly of claim 10, wherein the transparent resistive heating element includes a layer of graphene arranged as an electrical circuit on the transparent substrate and adapted to be coupled with a source of electrical power.

12. The electronic dimmable window assembly of claim 11, wherein the heating element is arranged in a serpentine pattern on the transparent substrate.

13. The electronic dimmable window assembly of claim 11, wherein:
the heater further includes a transparent panel overlying and configured to protectively cover the layer of graphene, and
wherein the layer of graphene is sandwiched between the transparent panel and the transparent substrate.

14. The electronic dimmable window assembly of claim 10, wherein:
the transparent heater panel is spaced apart from the at least one outer windowpane, and
the transparent heater panel is located between the electronic dimmable window panel and the at least one outer windowpane.

15. The electronic dimmable window assembly of claim 10, wherein the transparent heater panel is mounted in contact with the electronic dimmable window panel.

16. A method of making an electronic dimmable window, comprising:
providing an electronically dimmable window panel;
forming a graphene heating element on a transparent substrate and operable to generate heat; and
mounting the transparent substrate in an aligned, side-by-side relationship with the electronic dimmable window panel such that the heat generated by the graphene heating element is transferred to the electronic dimmable window panel.

17. The method of claim 16, wherein mounting the transparent substrate includes installing the transparent substrate such that it contacts the electronic dimmable window panel.

18. The method of claim 16, further comprising:
placing a transparent panel over the transparent substrate to protectively cover the graphene heating element.

19. The method of claim 16, wherein forming the graphene heating element includes depositing graphene on the transparent substrate by one of:
physical vapor deposition,
chemical vapor deposition, and
printing.

20. The method of claim 16, further comprising:
forming a thermostatic control circuit on the transparent substrate operable to control the graphene heating element.
